(19) United States
(12) Patent Application Publication
(10) Pub. No.: US 2026/0208194 A1
(43) Pub. Date: Jul. 23, 2026

(54) Housing

(71) Applicant: Flexotronix Limited, Brighton & Hove (GB)

(72) Inventors: Robert STEVENS, Brighton & Hove (GB); Jeremy Mark BURBIDGE, Brighton & Hove (GB)

(73) Assignee: Flexotronix Limited, Brighton & Hove, ES (GB)

(21) Appl. No.: 19/140,874

(22) PCT Filed: Dec. 22, 2023
(86) PCT No.: PCT/GB2023/053369

§ 371 Date: Jun. 18, 2025

(30) Foreign Application Priority Data
Dec. 23, 2022 (GB) 2219689.3

(51) Int. Cl. B01L 3/00

(52) U.S. Cl. CPC B01L 3/508; B01L 2200/025; B01L 2200/12; B01L 2300/0627; B01L 2300/069; B01L 2300/0825; B01L 2300/0887; B01L 2300/123; B01L 2300/16

(57) ABSTRACT

A housing for a diagnostic device comprising a bottom layer comprising a metallised film laminate or foil laminate, a polymeric spacer layer, wherein the bottom layer and the spacer layer define at least one cavity; and a peelable upper layer comprising a foil laminate, the upper layer being removable from the housing to thereby expose at least a portion of the cavity.

### BACKGROUND TO THE INVENTION

The present invention relates to a housing, and in particular a housing for a diagnostic device.

Diagnostic devices, such as lateral flow tests, are well known for detecting the presence or absence of a particular biological substance, such as a protein, an antigen, a hormone, or any other molecule, by the detection of the substance from a sample. Such devices typically comprise a lateral flow strip, which provides the detection function, enclosed inside a housing. Conventional housings are typically formed of an injection-moulded plastic housing, with an opening in the top through which the lateral flow test can be accessed.

However, such housings have several disadvantages. First, they are slow and typically involve manual intervention to manufacture and assemble. Second, the structure of the housing typically means that it is not possible to seal the contents of the housing (e.g. a lateral flow test strip) from atmospheric conditions (i.e. moisture and air) or from dirt, dust and contaminants. Thus, during transport, such known devices typically need to be contained within a hermetically sealed bag, containing a desiccant, in order to protect the device from moisture and contaminants coming into contact with device before it is used, which may otherwise render the device inoperative or cause it to function sub-optimally. It is an aim of the present invention to at least partially address one or more of the problems noted above.

### SUMMARY OF THE INVENTION

A first aspect of the present invention provides a housing for a diagnostic device comprising: a bottom layer comprising a metallised film laminate or a foil laminate; a polymeric spacer layer, wherein the bottom layer and the spacer layer define at least one cavity; and a peelable upper layer comprising a metallised film laminate or a foil laminate, the upper layer being removable from the housing to thereby expose at least a portion of the cavity.

The upper layer may therefore combine with the spacer layer and the bottom layer to seal the cavity against external factors such as moisture or contamination.

Thus the housing may be sealed on manufacture and remain sealed until use, when the contents can be accessed by a user peeling off the upper layer. Such housings may not need to be packed in separate bags or provided with separate desiccants.

The layered structure of the housing may also mean that the housing is suitable for manufacture by a printing process, such as flexographic printing. This can enable rapid, and potentially parallel, manufacture of housings in large quantities and without manual intervention.

Multiple cavities may be defined by the bottom layer and the spacer layer and preferably sealed by the upper layer.

The housing may further comprise an aperture layer comprising at least one aperture, the aperture layer being disposed between the spacer layer and the upper layer, wherein the aperture is at least partially aligned with the cavity such that removal of the peelable upper layer exposes the aperture and at least a portion of the cavity.

The housing preferably further comprises a layer of non-permanent adhesive between the peelable upper layer and the aperture layer. The non-permanent adhesive can facilitate the peelable nature of the upper layer, whilst ensuring that the upper layer stays bonded to the aperture layer until it is peeled off, thus sealing the inside of the housing (including the cavity).

In certain embodiments the aperture layer comprises a flexible film.

The housing may further comprise an adhesive layer between the aperture layer and the spacer layer.

The housing may further comprise an adhesive layer between the bottom layer and the spacer layer.

The housing may further comprise an adhesive kill material or non-adhesive coating applied to the adhesive layer of either the upper layer or the aperture layer at locations where at least one aperture aligns with the cavity. This can ensure that any components located within the cavity (such as a lateral flow test strip or other diagnostic device) do not come into contact with the adhesive and thereby reduce or avoid the possibility of the components being damaged or contaminated by the adhesive.

The housing may further comprise a desiccant material within the cavity. The desiccant material can act to absorb most, preferably all, of the moisture in the cavity. With the sealing effect of the bottom layer and upper layer, this can ensure that a low or zero moisture environment is maintained in the cavity over a long period.

In particular embodiments the desiccant comprises a silica gel and/or a molecular sieve. In certain embodiments the desiccant is an absorbent paper with silica gel integrated therein. The housing may further comprise one or more diagnostic components, such as a lateral flow test strip. The diagnostic components may be disposed within said at least one cavity. In embodiments having a lateral flow test strip, the lateral flow test strip may comprise at least one layer of an open porous membrane material such as nitrocellulose.

The lateral flow test trip may alternatively or additionally comprise one or more non-woven fibrous layers. The non-woven fibrous layer may have a coating of stabilised gold-antibody conjugate materials or stabilised gold-molecular imprinted polymer (MIP) conjugate material which form a conjugate pad.

Alternatively or additionally the non-woven fibrous layer may include a biotinylated antibody or other linker molecules grafted to either an antibody of a molecular imprinted polymer (MIP) or to a molecular imprinted polymer (MIP).

The spacer layer may be formed from a substrate with low moisture vapour transmission rate such as polypropylene and is preferably flexible. Materials with an MVTR of below 20 g/m²/day are preferred and more preferably the material has an MVTR of below 10 g/m²/day or below 5 g/m²/day.

The metallised film laminate or foil laminate of either or both of the bottom layer and upper layer may include a flexible substrate.

In certain embodiments the flexible substrate is made up of a stack of metallised polyethylene terephthalate (PET) or metallised polypropylene or a mixture of the metallised polyethylene terephthalate and metallised polypropylene. However, other metallised films may also be used. The metallised films may be held together using a thermally cured adhesive.

The metallised film laminate or foil laminate may comprises at least one layer of thin film metal, and may comprise a plurality of layers of vacuum-deposited thin film metal.

The housing may further comprise one or more electronic or optoelectronic components arranged such that the components are located within the volume of at least one cavity defined within the housing. This may include the cavity defined by the bottom layer and the spacer layer, but may also include other cavities defined by or in other portions of the housing.

In certain embodiments the electronic components include one or more of: an energy storage device; an optical sensor; and/or a fluidic (or microfluidic) pump.

The spacer layer may be treated with a corona or plasma discharge treatment. This may increase the free surface energy of a polymer forming the spacer layer, which may in turn provide improved adhesive bonds when an adhesive is applied, both between the spacer layer and the bottom layer, and between the spacer layer and the aperture layer (when an aperture layer is present).

A further aspect of the present invention provides an assembly comprising a plurality of housings according to the above first aspect, including some, all or none of the optional and preferred features of that aspect, wherein each housing is connected to at least one other housing by joining portions in the bottom layer and/or the spacer layer.

Such an assembly of housings may provide for ease of packing or storage due to being joined together in a convenient manner (compared to, for example, individual housings of injection molded plastic). Further, when a rotary die or other segmentation process is used, the finished tests may be wound up onto a roll or spool, which may enable a large number of housings to be transported conveniently as an assembly on a single roll.

### BRIEF DESCRIPTION OF THE DRAWINGS

Embodiments of the present invention will now be described, by way of non-limitative example only, with reference to the accompanying drawings, in which:

FIG. 1 shows an exploded perspective view of a housing according to the present invention;

FIG. 2 shows top views of each of the layers of the device shown in FIG. 1;

FIG. 3 shows a schematic cross-section through the housing of FIG. 1;

FIG. 4 shows a top view of the assembled housing of FIG. 1;

FIG. 5 shows a top view of the assembled housing of FIG. 1 with the top layer removed and without the lateral flow test strip or aperture layer; and

FIG. 6 shows an assembly of five housings.

### DETAILED DESCRIPTION

The present invention relates to a housing for a diagnostic device, and a diagnostic device comprising such a housing. It will be understood that the housing may be used to house any suitable diagnostic device, including, but not limited to, a lateral flow test strip, or a different type of point of care diagnostic test such as passive or active electronic point of care diagnostic tests. Passive tests utilise harvested electromagnetic and thermal energy from the local environment, whereas active tests incorporate in built energy storage, such as a battery, fuel cell or super capacitor. The energy available is used to control the interaction of the user through visual information display, acoustic and vibrational means. Different types of sensing approach can be used including, but not limited to: electrochemical sensing (amperometric, potentiometric, impedimetric, photoelectrochemical, and electrogenerated chemiluminescence), optical absorption, optical reflectance, magnetic, luminescent, colorimetric, and/or chemiluminescence.

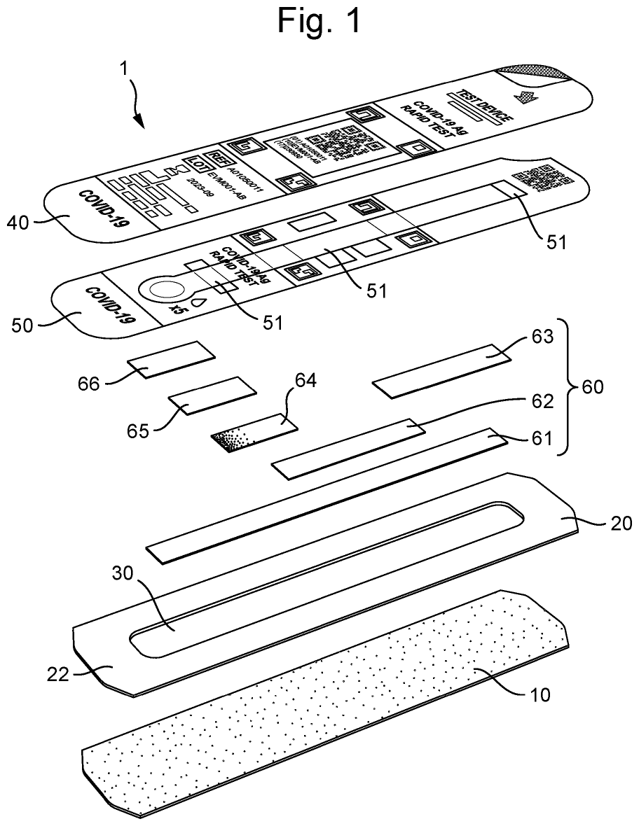

As shown in FIG. 1, the housing 1 comprises a bottom layer 10, a polymeric spacer layer 20, and a peelable upper layer 40. In the example shown in FIG. 1, the housing 1 has a generally elongate shape, which is substantially rectangular with rounded or partially rounded ends.

The polymeric spacer layer 20 comprises a cut-out portion 22, which in the example shown in FIG. 1, is an elongate slot cut in the spacer layer 20. When the spacer layer 20 and the bottom layer 10 are placed in abutment with each other, the cut-out portion in the spacer layer 20 and the area of the upper surface of the bottom layer which is inside the perimeter of the cut-out portion together define a cavity 30. The cavity 30 may be used to contain (i.e. house) a diagnostic device.

It will be apparent from FIG. 1 that, when the device is assembled, the peelable upper layer 40 covers the cavity 30. The upper layer 40 is also peelable from the housing 1. In other words, it can be removed from the housing by a user to thereby expose at least a portion of the cavity 30. In order to allow the upper layer 40 to be peeled off the housing, a relatively weak (i.e. non-permanent) adhesive may be used to attach the upper layer 40 to the device during manufacture.

The bottom layer 10 comprises a flexible material which is a metallised film laminate or a foil laminate. Preferably, a printable metallised film or foil laminate with a low MVTR (moisture vapour transmission rate) is used. Materials with an MVTR of below 0.1 g/m²/day are preferred. The MVTR of the metallised film in the embodiment is 0.02 g/m²/day.

Likewise, the upper layer 40 also comprises a flexible material which is a metallised film laminate or a foil laminate. Preferably, a printable metallised film or foil laminate with a low MVTR is used. Materials with an MVTR of below 0.1 g/m²/day are preferred. The MVTR of the metallised film in the embodiment is 0.02 g/m²/day. It will be understood that the foil laminate of the peelable upper layer 40 and the bottom layer 10 may be the same as, or different to, each other.

Thus, when the device is assembled, the presence of the bottom layer 10 and the peelable upper layer 40 either side of the polymeric spacer layer 20 seals off the cavity 30 so that substantially no moisture, or very little moisture, can enter the cavity through the peelable upper layer and the bottom layer. To minimise the transmission of water through the adhesives (i.e. the permanent and peelable adhesives on the upper layer and the permanent adhesive on the bottom layer), the thickness of the adhesive layers used are below 15 micrometres in thickness. To reduce the transfer rate hygroscopic nanoparticulates may be added to any or all of the adhesives to slow the transfer of water molecules from the external environment to the internal cavity. Thus, housing 1 provides good sealing of the contents of the cavity, without the need for further components (e.g. a bag in which the housing is sealed, as in the known arrangements described above).

It will be apparent that, when the peelable upper layer 40 shown in FIG. 1 is completely removed from the housing, the entire area of the cavity 30 is exposed. However, it will also be understood that, in some arrangements, only part of the upper layer 40 may be peelable, such that removing the upper layer exposes only part of the cavity. In some arrangements, the upper layer 40 may be disposed on the spacer layer 30 with only a layer of adhesive therebetween (and no further layers). Alternatively however, as will be explained below, a further layer may be present between the polymeric spacer layer 20 and the upper layer 40 such that parts of the cavity are “masked off” by the additional layer.

In particular, in some arrangements (and as shown in FIG. 1), the housing may further comprise an aperture layer 50 comprising at least one aperture 51. When the device is assembled, the aperture layer 50 is placed between the polymeric spacer layer 20 and the upper layer 40. In some arrangements, the aperture layer may comprise (or be formed of) a biaxially-oriented polypropylene film (BOPP), biaxially-orientated polyethylene terephathalate (BOPET), biaxially-orientated Poly Lactic Acid (BOPLA), polyester (Melinex), and many others including the flexible, printable metalised films used for the upper layer and the bottom layer.

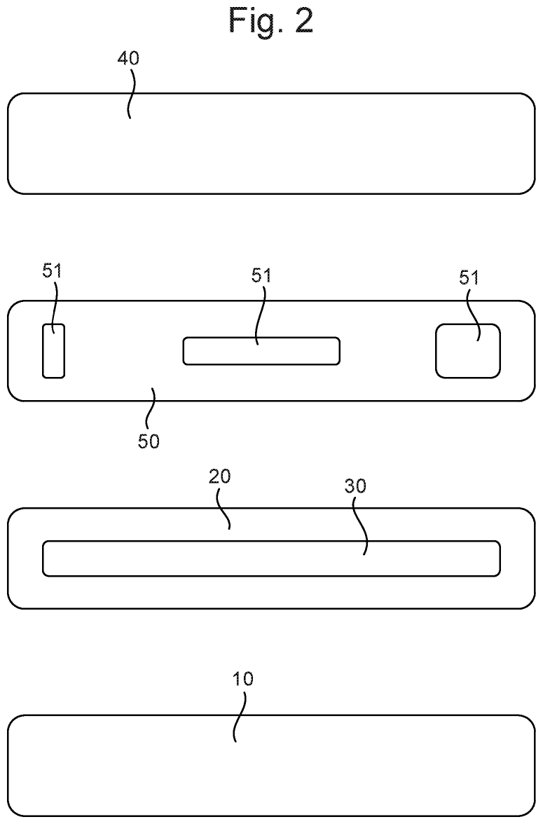

In the arrangement shown in FIGS. 1 and 2, the aperture layer 50 comprises three apertures (i.e. openings or holes) 51 distributed along the length of the aperture layer. It will be understood that, depending on the application of the housing, any suitable pattern of apertures (i.e. one aperture, or a plurality of apertures) of any suitable shape may be provided at any suitable positions in the aperture layer 50.

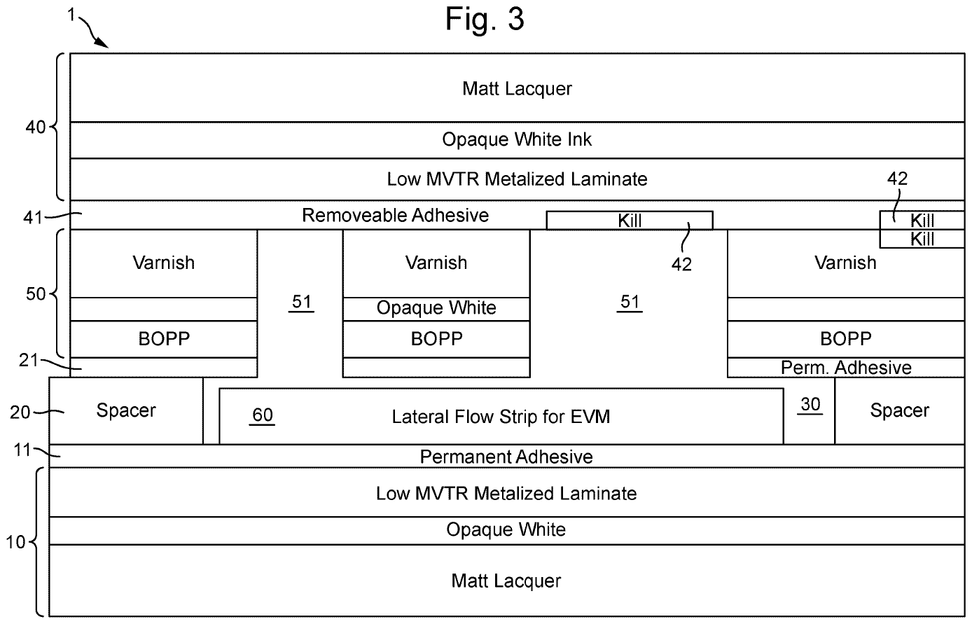

When an aperture layer 50 is present, the aperture or apertures are at least partially aligned with the cavity 30, so that when the peelable upper layer 40 is removed, part of the cavity is exposed, and part of the cavity is covered by the aperture layer. This can be seen in the schematic (and not-to-scale) cross-section view of FIG. 3. This may mask off parts of the area of the cavity. In turn, this may prevent contact between external objects and specific parts of the diagnostic device which is placed in the cavity. In addition this may also provide compression at selected parts of the diagnostic strip to ensure continuity of the fluidic path from one part of the diagnostic strip to another part. It may also provide the means to align printed hybrid electronic features to for an electronic/optoelectronic diagnostic device.

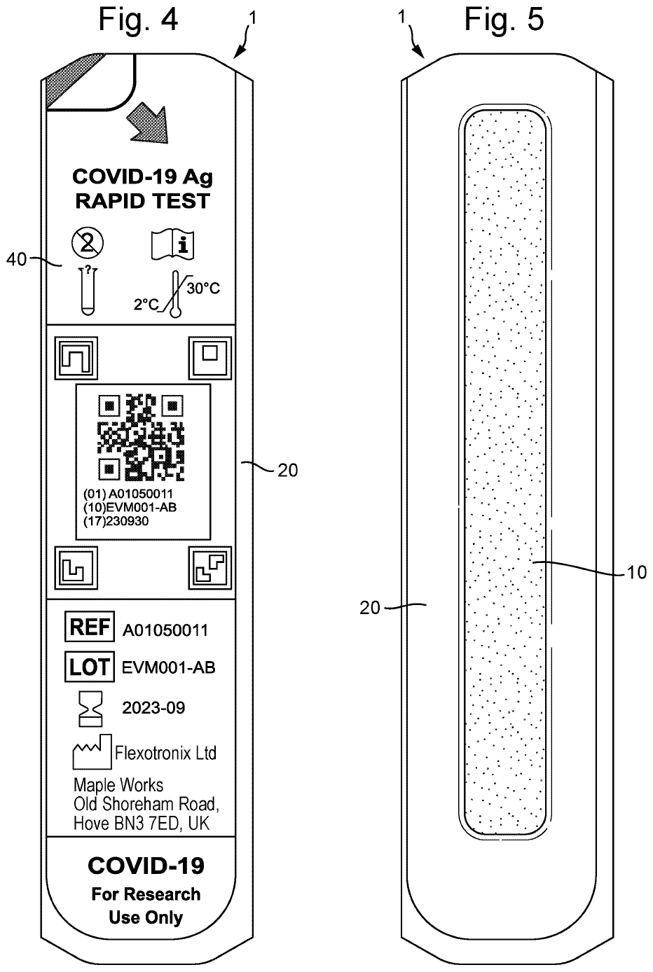

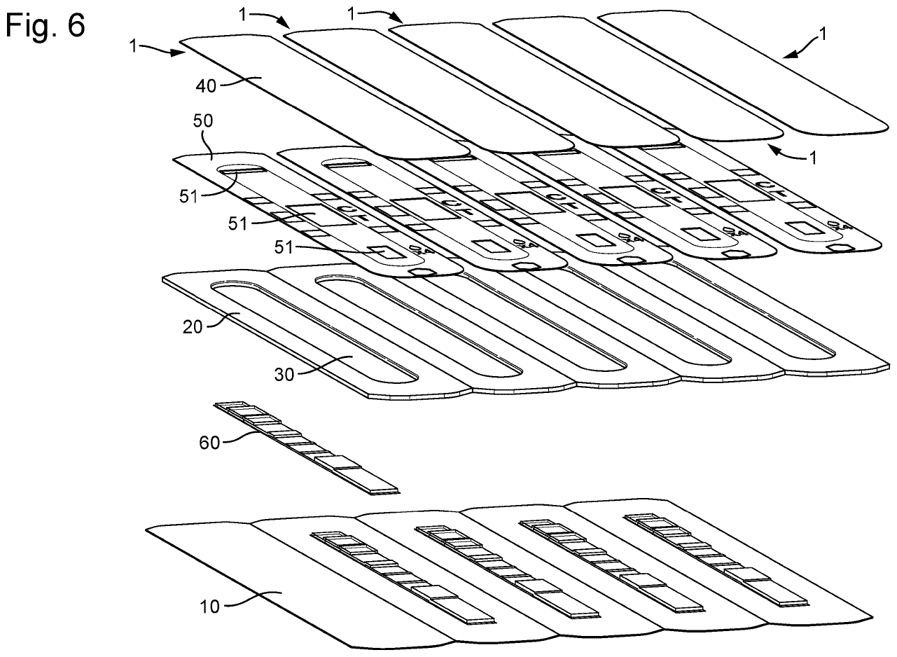

FIG. 4 shows a view of a housing with the peelable upper layer 40 in place, and FIG. 5 shows the same housing with the peelable upper layer 40 removed. It can be seen from FIG. 5 that the removal of the upper layer 40 results in the cavity 30 being exposed. If an aperture layer was present, then this would mask off certain parts of the cavity 30 as explained above As explained above, this may allow access to the diagnostic device disposed in the cavity (e.g. a lateral flow strip) when required, whilst also allowing sealing of the cavity without the need for further components (such as a sealed bag).

In the arrangement shown in FIG. 1, the bottom layer, 10, the spacer layer 20, and the upper layer 40 are all of substantially similar dimensions, such that when the layers are joined together, they form a single unit with an outline shape where the spacer and the bottom layer are the same and the upper layer is smaller than the outline of the spacer and bottom layer, but larger than the perimeter of the cavity in the spacer layer. However, it will be understood that, in some arrangements, the different layers may have different shapes. For example, some layers may only partially overlap or the layers may be such that the outline shape of each layer is the same.

The polymeric spacer layer 20 may be formed of any suitable polymer. However, in a preferred arrangement, the polymeric spacer layer comprises polypropylene, and may be formed of polypropylene. The thickness of the polymeric spacer layer 20 may be 0.4-1.5 mm, preferably 0.6-1 mm, and more preferably 0.6-0.8 mm. In a particularly preferred arrangement, the spacer layer 20 may be about 0.72 mm thick. The thickness of the spacer layer is determined by the choice and thickness and overlaps of materials used to make the diagnostic strip. Prior to assembly, the polymeric spacer layer may be subjected to a corona or plasma discharge treatment. This may increase the free surface energy of the polymer forming the spacer layer, which may in turn provide improved adhesive bonds when an adhesive is applied, both between the spacer layer 30 and the bottom layer 10, and between the spacer layer 30 and the aperture layer 50 (when an aperture layer is present).

The different layers of the housing may be adhered together using any suitable adhesive. In some arrangements, a permanent adhesive 11 may be used between the spacer layer 20 and the bottom layer 10. Likewise, where an aperture layer 50 is present, a permanent adhesive 21 may be used between the aperture layer 50 and the spacer layer 20.

In order to allow the upper layer 40 to be peelable from the rest of the housing, a non-permanent adhesive 41 (i.e. an adhesive which is weaker than a permanent adhesive) may be used.

In any of the layers of adhesive between the various other layers of the housing, a pressure sensitive adhesive may preferably be used. This allows the layers to be easily adhered together during manufacture by the application of pressure, which may provide improved ease of manufacturing.

Where an aperture layer 50 is present, it may be preferable to prevent adhesive 41 from the underside of the upper layer 40 (i.e. the adhesive joining the upper layer 40 to the aperture layer 50) from contacting the contents of the cavity 30 through the apertures 51. Thus, an adhesive kill 42 or release lacquer or other non-adhesive coating may be applied during manufacture to the underside of the upper layer 40 at locations where the apertures 51 align with the cavity 30. The adhesive kill layer 42 of non-adhesive coating establishes a non-adhesive region or regions on the upper layer 40 at locations where the adhesive 41 might otherwise come into contact with the contents of the cavity 30.

In some arrangements, a desiccant material (not shown) is disposed within the cavity 30. This may reduce the amount of, and preferably prevent any, moisture from coming into contact with the contents of the cavity 30 which typically will require low moisture content to preserve functional performance. This may be useful in a number of applications, including when a lateral flow strip is provided in the cavity (although a desiccant may also be provided when a lateral flow strip is not present).

In such an arrangement, because the desiccant is sealed in the cavity 30 by the foil laminate layers, there is no need to package the housings of the present invention in a separate pouch, with a separate desiccant provided inside the pouch. Thus, the present invention may provide a more compact housing, which may be easier and of a lower cost to transport.

In some arrangements, the desiccant comprises a silica gel, and in further preferable arrangements, include an absorbent paper with silica gel therein.

As shown in FIG. 1, in some embodiments, a lateral flow test strip 60 is provided in the cavity 30. However, the skilled person will appreciate that the later flow test strip 60 is only one example of a component which can be provided within the housing. Other components, including other diagnostic components for different type of point of care diagnostic tests (including passive or active electronic point of care diagnostic tests) can also be included in the housing.

FIG. 1 also shows details of lateral flow test strip 60. In some arrangements, the lateral flow test strip 60 comprises at least one layer of an open porous membrane material, which may preferably be nitrocellulose.

In the embodiment of FIG. 1, the lateral flow test strip is made up of an adhesive backing card layer 61, on which a nitrocellulose membrane 62, and absorbent desiccant pad 63 and a conjugate pad 64 are assembled. A biotinylated pad 65 and a sample pad 66 are layered on top of the conjugate pad 64.

The lateral flow test strip 60 may comprise one or more non-woven fibrous layers (such as glass fibre layers), on which various functional materials which may be disposed in order to provide the desired detection of a biological substance. The specific arrangement of the layers depends on the particular application of the lateral flow strip. However, in some arrangements, the fibrous layers may include one or more of a gold antibody conjugate pad and a biotinylated antibody pad. The antibody could be natural or synthetic (e.g. a Molecularly Imprinted Polymer—MIP)

The flexible substrate of either or both of the bottom layer 10 and the upper layer 40 may be a metallised film. In some preferable arrangements, the foil laminate may be a metallised PET film. The foil laminate may also have information, instructions, or designs printed on the surface, which may be produced using known and well established printing technologies such as flexographic printing, offset printing, inkjet printing, gravure and screen printing and combinations thereof.

In a preferable arrangement, the metallised film laminate comprises a plurality of layers with vacuum deposited aluminium films on one or both sides, laminated together and held in place with adhesive. In particularly preferable arrangements, the metallised film laminate consists of five laminated film layers held together with adhesive. The outer two layers each have one side metallised. The two outer surfaces of the stack are non-metallised but treated to allow them to be printed. The remaining three “core” layers have both sides metallised. Thus the metallised film laminate comprises at least eight thin film layers of aluminium. This may provide particularly good moisture resistance.

In other preferable arrangements, the metallised film may be a metal foil bonded to a polymer film (i.e. a single layer of polymer laminated with a single layer of metal foil). In such arrangements, the metal foil layer may be formed of aluminium and the polymer may be polypropylene. In other preferable arrangements, the foil laminate may be a single laminated film layer (i.e. a single layer of metal foil and a layer of polymer bonded on each side of the metal layer). Again, in such arrangements, the metal layer may be formed of aluminium and the polymer may be polypropylene. Such layers may have low cost due to their simple construction, whilst also providing good moisture resistance. In any of the above arrangements, an adhesive, such as a pressure sensitive adhesive, may be present on one or both of the surfaces of the metal foil layer. In some arrangements, a permanent pressure sensitive adhesive may be present on one side of the foil laminate or metallised film. In some arrangements a removable pressure sensitive adhesive present on one side of the foil laminate or metallised film. It will be appreciated that pressure sensitive and permanent adhesives may be applied respectively on different sides of the foil laminate or metallised film. Further, as described above, it will be understood that the polymer layers may have information, instructions, or designs printed on the surface.

In a further arrangement, one or more electronic components may be provided in the housing. These electronic components may be disposed in the cavity and/or disposed on the aperture layer, depending on the particular purpose and application of the electronic components.

The electronic components may include one or more of a battery, an optical sensor, and a microfluidic pump, or a combination thereof. This may allow the housing to provide functionality beyond that of conventionally known housings for diagnostic devices.

For example, a battery may be used in order to provide power to other components of the test. The battery may be a conventional coin cell

An optical sensor may be used in order to detect the result of the test, and provide an electronic or optoelectronic output, rather than the user having to manually inspect the result of the test (e.g. by observing the absence or presence of a line on a lateral flow strip).

A microfluidic pump may be used to move fluid from one part of the housing to another. Such a pump may be a thermopneumatic pump, a piezoelectric pump, an expansion wax pump or a pump using a shape memory alloy.

The housing 1 of the present invention may be produced using any suitable production method. In some arrangements, the individual layers may be produced using extrusion, casting, wirebar coating, slot die coating, gravure coating and/or printing methods such as flexographic printing, offset printing, inkjet printing, gravure and screen printing and combinations thereof, and may be sandwiched together using any suitable lamination technique. It will be understood that multiple tests may be produced in a single batch, which may be either separated (using, for example, a slitting machine), or kept together as an assembly comprising a plurality of housings.

In one example, five housings may be produced side-by-side, as shown in FIG. 6. In this situation, a plurality of joining portions may be present between adjacent tests, in order to join them together. These joining portions may be produced by selectively cutting through the thickness of the region between the individual housings, such that they are joined by parts of the spacer layer 20, and/or by parts of the bottom layer 10.

In one arrangement, the spacer layer 20 may be entirely cut through, and small portions of the bottom layer 10 may be kept joined, easily allowing the tests to be separated when required. Alternatively, both spacer layer 20 and bottom layer 10 are partially cut through leaving portions of both to keep the required number of housings joined. This arrangement is shown in the schematic cross section view in FIG. 3, where the lower portion (in the figure) of the spacer layer 20 and bottom layer 10 extend beyond the aperture layer 50 and the upper layer 40 and would, in an assembly of multiple housings 1, be joined to the spacer layer and bottom layer of an adjacent housing. Alternatively portions of just the spacer layer 20 may be kept joined between the housings.

Such an assembly of multiple tests may provide the advantage or ease of packing due to being joined together in a convenient manner (compared to, for example, conventional housings of injection molded plastic, which are individually produced). Further, when a rotary die or other segmentation process is used, the finished tests may be wound up onto a roll or spool, which may enable a large number of housings to be transported conveniently on a single roll.

It should be understood by those skilled in the art that while the present invention has been described with reference to exemplary embodiments, it is not limited to the disclosed exemplary embodiments. Various modifications, combinations, sub-combinations and alterations may occur depending on design requirements and other factors insofar as they are within the scope of the appended claims or the equivalents thereof. Features from any example or embodiment of the present disclosure can be combined with features from any other example or embodiment of the present disclosure.

1. A housing for a diagnostic device comprising:
a bottom layer comprising a metallised film laminate or a foil laminate;
a polymeric spacer layer, wherein the bottom layer and the spacer layer define at least one cavity; and
a peelable upper layer comprising a metallised film laminate or a foil laminate, the upper layer being removable from the housing to thereby expose at least a portion of the cavity.

2. The housing of claim 1, further comprising an aperture layer comprising at least one aperture, the aperture layer being disposed between the spacer layer and the upper layer;
wherein the aperture is at least partially aligned with the cavity such that removal of the peelable upper layer exposes the aperture and at least a portion of the cavity.

3. The housing of claim 2, further comprising a layer of non-permanent adhesive between the peelable upper layer and the aperture layer.

4. The housing of claim 2, wherein the aperture layer comprises a flexible film.

5. The housing of claim 2, further comprising an adhesive layer between the aperture layer and the spacer layer.

6. The housing of claim 5, further comprising an adhesive kill material or non-adhesive coating applied to the adhesive layer of either the upper layer or the aperture layer at locations where at least one aperture aligns with the cavity.

7. The housing of claim 1, further comprising a desiccant material within the cavity.

8. The housing of claim 7, wherein the desiccant comprises either one or both of a silica gel and a molecular sieve, or wherein the desiccant is an absorbent paper with silica gel integrated therein.

9. (canceled)

10. The housing of claim 1, further comprising a lateral flow test strip disposed within said at least one cavity.

11. The housing of claim 10, wherein the lateral flow test strip comprises either one or both of: at least one layer of an open porous membrane material; and one or more non-woven fibrous layers, and
optionally, wherein the open porous membrane material includes nitrocellulose.

12. (canceled)

13. The housing of claim 11, wherein the non-woven fibrous layer has a coating of stabilised gold-antibody conjugate material or stabilised gold-molecular imprinted polymer (MIP) conjugate material which form a conjugate pad, or wherein the non-woven fibrous layer includes a biotinylated antibody or other linker molecules grafted to either an antibody of a molecular imprinted polymer (MIP) or to a molecular imprinted polymer (MIP).

14. (canceled)

15. The housing of claim 1, wherein the spacer layer is formed from a substrate with low moisture vapour transmission rate.

16. The housing of claim 1, wherein the metallised film laminate or foil laminate of either or both of the bottom layer and upper layer includes a flexible substrate.

17. The housing of claim 16, wherein the flexible substrate is made up of a stack of metallised polyethylene terephthalate or metallised polypropylene or a mixture of the metallised polyethylene terephthalate and metallised polypropylene or other metallised films, preferably held together using a thermally cured adhesive.

18. The housing of claim 1, wherein the metallised film laminate or foil laminate comprises at least one layer of thin film metal, and optionally comprises a plurality of layers of vacuum deposited thin film metal.

19. The housing of claim 1, further comprising an adhesive layer between the bottom layer and the spacer layer.

20. The housing of any claim 1, further comprising one or more electronic or optoelectronic components arranged such that the components are located within the volume of at least one cavity defined within the housing.

21. The housing of claim 20, wherein the one or more electronic or optoelectronic components includes at least one of an energy storage device, an optical sensor, and a fluidic pump.

22. (canceled)

23. (canceled)

24. The housing of claim 1, wherein the spacer layer is treated with a corona or plasma discharge treatment.

25. An assembly comprising a plurality of housings according to claim 1, wherein each housing is connected to at least one other housing by joining portions in either one or both of the bottom layer and the spacer layer.
